(19) United States
(12) Patent Application Publication
(10) Pub. No.: US 2019/0089674 A1
(43) Pub. Date: Mar. 21, 2019

(54) COMMUNICATION SYSTEM, FLOW CONTROL APPARATUS, FLOW PROCESSING APPARATUS, AND CONTROL METHOD

(71) Applicant: NEC CORPORATION, Tokyo (JP)

(72) Inventor: Kakeru SEINO, Tokyo (JP)

(73) Assignee: NEC CORPORATION, Tokyo (JP)

(21) Appl. No.: 16/085,295

(22) PCT Filed: Mar. 23, 2017
(86) PCT No.: PCT/JP2017/011805

§ 371 Date: Sep. 14, 2018

(30) Foreign Application Priority Data
Mar. 30, 2016 (JP) 2016-068843

(51) Int. Cl. H04L 29/12; H04L 12/46

(52) U.S. Cl. CPC H04L 61/2046; H04L 12/4641; H04L 61/6022

(57) ABSTRACT

A flow processing apparatus in a Q-in-Q model may receive frames having different IVIDs but the same sender MAC address, in which case a MAC duplication problem occurs in the flow processing apparatus. A communication system according to an embodiment of the present invention includes: a flow processing apparatus that transmits a MAC duplication notification indicating an occurrence of MAC duplication in a case in which a plurality of frames received from different ports and belonging to a predetermined virtual network have the same sender MAC address; and a flow control apparatus that changes the configuration of the predetermined virtual network in a case in which the MAC duplication notification has been received from the flow processing apparatus.

### TECHNICAL FIELD

The present invention relates to a communication system, a flow control apparatus, a flow processing apparatus, and a control method.

### BACKGROUND ART

In order to construct large-scale virtual networks, a virtual network configuration model (Q-in-Q model) that uses Q-in-Q has been employed.

In the Q-in-Q model, a control apparatus controls a plurality of flow processing apparatuses by using a control protocol, such as an OpenFlow, based on a virtual network configuration set by a user or an upper level control apparatus. For example, the Q-in-Q model includes, a configuration in which virtual bridges are arranged under the control of a virtual network and coordinates virtual network identifications (IDs) and virtual bridge IDs that are managed by a flow control apparatus with outer VLAN IDs (OVID) and inter VLAN IDs (IVID) of frames, respectively, thus realizing media access control (MAC) forwarding for each of the virtual bridges.

PTL 1 describes that, in a network environment configured by virtual machines constructed virtually and network devices, if same MAC addresses are set to generated virtual machines, normal communication to the virtual machines in operation may become impossible.

PTL 2 discloses that two client apparatuses may be assigned to different subnets to prevent irregular communication due to duplication of the MACs of the client apparatuses.

### CITATION LIST

### Patent Literature

[PTL 1] JP 2013-168771 A

[PTL 2] JP 2012-525018 A

### SUMMARY OF INVENTION

### Technical Problem

As described above, the invention described in PTL 2 prevents the two client apparatuses with the same MAC addresses from belonging to the same subnet.

However, according to the invention described in PTL 2, since the two client apparatuses with the same MAC addresses cannot be assigned in the same subnet, setting flexibility of the MAC address becomes lower. In addition, since a core switch in the Q-in-Q model sometimes receives frames that include different IVIDs but include the same source MAC addresses, the core switch raises a problem of the MAC duplication.

In view of the problems above, the present invention is to provide a communication system, a flow control apparatus, a flow processing apparatus, and a control method that can suppress an occurrence of MAC duplication.

### Solution to Problem

An exemplary of the invention is a communication system. The communication system includes a flow processing apparatus that transmits a MAC (Media Access Control) duplication notification indicating an occurrence of MAC duplication, when a plurality of frames received from different ports and belonging to a predetermined virtual network include same source MAC addresses, and a flow control apparatus that changes a configuration of the predetermined virtual network, when receiving the MAC duplication notification from the flow processing apparatus.

Another exemplary of the invention is a flow control apparatus. The flow control apparatus is capable of controlling a flow processing apparatus that processes a plurality of frames belonging to a predetermined virtual network. The flow control apparatus includes MAC (Media Access Control) duplication control means for performing a requirement for change of a configuration of the predetermined virtual network, when the MAC duplication control means receives a MAC duplication notification indicating an occurrence of MAC duplication in the plurality of frames from the flow processing apparatus, and virtual network management means for changing the configuration of the predetermined virtual network in response to the requirement.

Another exemplary of the invention is a control method. The control method includes transmitting a MAC (Media Access Control) duplication notification indicating an occurrence of MAC duplication when a plurality of frames received from different ports and belonging to a predetermined virtual network include same source MAC addresses, and changing a configuration of the predetermined virtual network, when the MAC duplication notification is received.

### Advantageous Effects of Invention

The flow processing apparatus, the communication system, and the communication method of the present invention can suppress an occurrence of MAC duplication.

### BRIEF DESCRIPTION OF DRAWINGS

FIG. 1 is a system configuration example of a communication system of a first example embodiment.

FIG. 2 is a configuration example of a flow processing apparatus of the first example embodiment.

FIG. 3 is a configuration example of the flow control apparatus in the first example embodiment.

FIG. 4 is a flow chart that illustrates an example of operations of the flow processing apparatus in the first example embodiment.

FIG. 5 is a flow chart that illustrates an example of operations of the flow control apparatus in the first example embodiment.

FIG. 6 is a configuration example of a communication system of a second example embodiment.

FIG. 7 is another configuration example of the communication system of the second example embodiment.

FIG. 8 is a configuration example of a flow processing apparatus of the second example embodiment.

FIG. 9 is a diagram that illustrates configuration examples of entries that are stored in each table.

FIG. 10 is a flow chart that illustrates an example of operations of the flow processing apparatus in the second example embodiment.

FIG. 11 is another configuration example of the flow processing apparatus of the second example embodiment.

FIG. 12 is another configuration example of the flow processing apparatus of the second example embodiment.

FIG. 13 is another configuration example of the flow processing apparatus of the second example embodiment.

FIG. 14 is a flow chart that illustrates an example of operations of the flow control apparatus in the second example embodiment.

FIG. 15 is another configuration example of the flow processing apparatus of the second example embodiment.

FIG. 16 is another configuration example of the flow processing apparatus of the second example embodiment.

FIG. 17 is another configuration example of the flow processing apparatus of the second example embodiment.

### EXAMPLE EMBODIMENT

Hereinafter, example embodiments and examples of the present invention will be described with referring to the drawings. Each example embodiment is exemplification, and the present invention is not limited to each example embodiment. Note that reference signs of the drawings applied in this summarization are applied to each element for convenience as one example for helping understanding of the invention, and the description of this summarization is not intended to apply any limitations to the present invention.

### First Example Embodiment

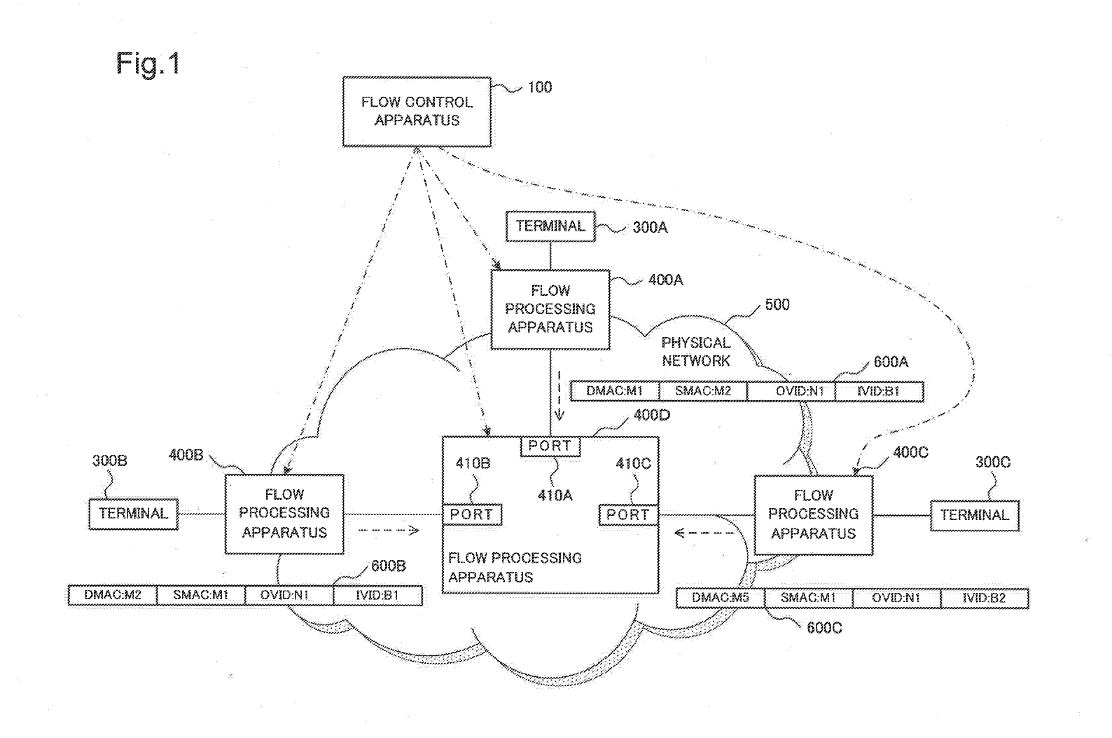

FIG. 1 is a diagram illustrating a system configuration example of a communication system in a first example embodiment of the present invention.

As described in FIG. 1, the communication system in the first example embodiment includes a flow control apparatus 100, terminals 300, and flow processing apparatuses 400. The flow processing apparatuses 400 are included in a physical network 500.

For example, the flow control apparatus 100 can manage nodes that execute packet processing in a centralized administration system architecture.

An example of the centralized administration system architecture includes an OpenFlow network. In the OpenFlow network, a conventional switch mechanism is separated into an openflow controller (OFC) that is a module in which route determination processing can be changed by programming from outside and an openflow switch (OFS) that is a module to perform only packet forwarding processing.

The term OFS in the OpenFlow network refers to an edge switch and a core switch that form the OpenFlow network and are under the control of the OFC. In the OpenFlow network, the OFC operates a flow table of the OFS, thus controlling behavior of the OFS.

The term flow table refers to a table in which flow entries that define a predetermined action to be performed for packets (communication data) matching with predetermined conditions (rules) are registered.

Each OFS retains at least one flow table. The OFC retains all flow tables including the same contents as the flow tables of each OFS under the control of the OFC. Namely, the OFC retains a master table of the flow tables of each OFS. Note that the term “retaining a flow table(s)” means managing the flow table(s). If the flow table(s) can be managed via a network or the like, the flow table(s) may not be present inside of the OFC itself in fact. For example, it is considered that the OFC and the OFS share the same flow table present on the network.

A rule for the flow entry is defined and distinguishable by various combinations by using any of or all of a Destination Address, a Source Address, a Destination Port, a Source Port that are included in header fields of each protocol layer of packets. Note that it is assumed that the addresses above include a media access control address (MAC address) and/or an Internet protocol address (IP address). In addition to the foregoing, information of Ingress Port can be used as the rule for the flow entry as well. Furthermore, a rule in which a part of (or all of) values in the header field of a packet indicating a flow is/are expressed by regular expression, a wild card “*” or the like can be also set as the rule for the flow entry.

The OFS processes packets matching with contents described in a column for the rules in accordance with contents described in a column for actions. The OFC can control processing for the matching packets by registering such flow entries to the OFS.

When a packet is delivered, the OFS reads header information of the packet (source information, destination information or the like) and retrieves a flow entry including rules matching with the packet (hereinafter, refers to as matching flow entries) among its own flow tables. As a result of the retrieving, when a matching flow entry is found, the OFS processes the packet in accordance with description in the action of the flow entry. Note that when a plurality of flow entries are found, the packet is processed in accordance with the highest-priority flow entry of the found flow entries. Meanwhile, as a result of the retrieving, when a matching flow entry is not found, the OFS determines the packet as a “first packet” and inquires how the packet should be processed to the OFC by forwarding a copy (reproduction) of the packet to the OFC.

When the OFC receives the inquiry from the OFS, the OFC performs route computation and derives an optimal route for forwarding the inquired packet to the destination. Furthermore, the OFC newly adds a flow entry for configuring the derived route to the flow table of the OFS. At this time, the OFC newly adds and registers the same flow entries to its own flow table as well.

The terminals 300 are devices that perform communication through the flow processing apparatus 400. Examples of the terminals 300 include mobile phones, personal computers (PCs), mobile routers, smart devices (e.g., smart meters monitoring home electrical power consumption; smart televisions; wearable terminals), machine to machine (M2M) devices. Examples of the M2M device include industrial equipment, cars, health care equipment, consumer electrical appliances in addition to the foregoing devices.

The flow processing apparatuses 400 are, for example, a core node included in a network using Q-in-Q (Q-in-Q model). Note that the flow processing apparatuses 400 forward received frames, based on MAC learning.

In the Q-in-Q model, the flow control apparatus 100 remotely controls the flow processing apparatuses 400 by using a control protocol, such as an OpenFlow, based on a virtual network configuration set by a user or an upper level control apparatus. The Q-in-Q model includes a simple configuration in which virtual bridges are arranged under the control of a virtual network and coordinates virtual network IDs and virtual bridge IDs that are managed by the flow control apparatuses with OVIDs and IVIDs of frames, respectively, thus realizing forwarding control for MAC forwarding on the virtual bridge basis on the virtual network basis.

However, control for the flow processing apparatuses 400 is executed by MAC forwarding on an OuterVLAN basis controllable by a hardware chip. Thus, when different frames that include the same source MAC addresses and the same OVIDs but different IVIDs are received in (received by) one flow processing apparatus 400 from different ports, MAC movement (MAC duplication) occurs each time the different frames are received. Namely, when different frames that include the same source MAC addresses and the same OVIDs but different IVIDs are received in a plurality of virtual bridges included in a certain virtual network, MAC movement (MAC duplication) occurs between the different IVIDs each time the different frames are received therebetween. In this case, this raises a problem in that the frame whose destination is the source MAC address is forwarded not only to a correct destination but also to a wrong destination.

Thus, in the first example embodiment, the flow control apparatus 100 controls each of frames in the state of MAC duplication in such a way that each of frames in the state of MAC duplication belongs different virtual networks from each other, thus preventing an occurrence of MAC duplication.

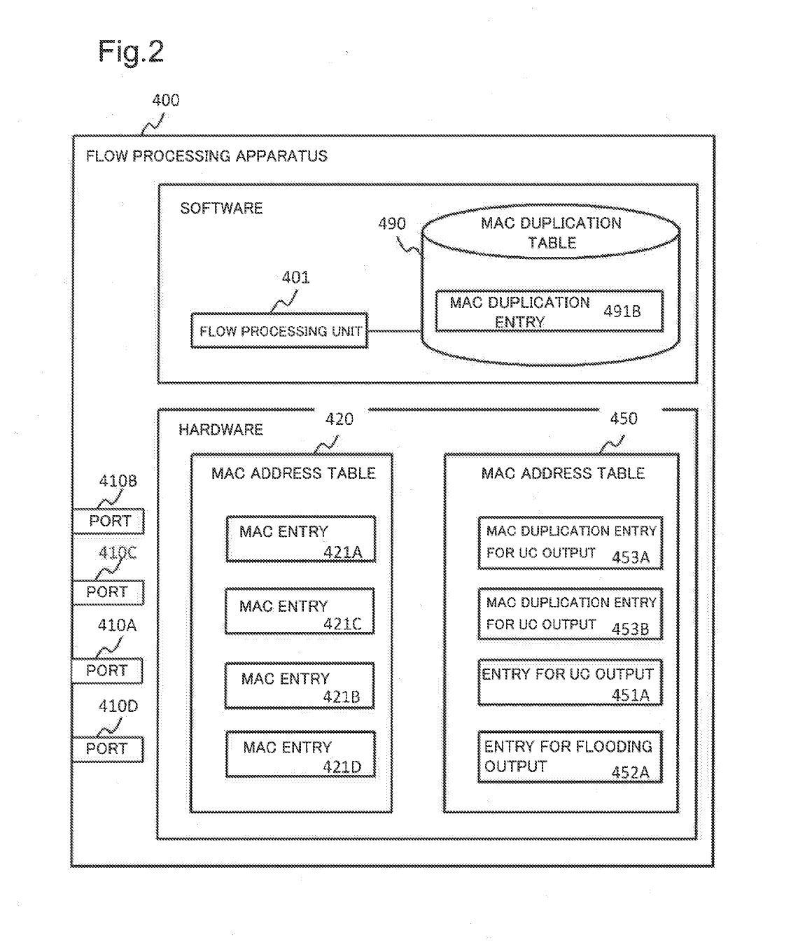

FIG. 2 is a diagram illustrating the configuration example of the flow processing apparatus 400. The flow processing apparatus 400 includes, for example, a flow processing unit 401, ports 410, a MAC address table 420, a MAC duplication table 490, and an access list table 450. The flow processing unit 401 and a MAC duplication table 490 are configured on a software. The ports 410, the MAC address table, and the access list table 450 are configured as a hardware. Note that in the flow processing apparatus 400, the flow processing unit 401 and/or the MAC duplication table 490 configured on the software may be implemented on the hardware.

The ports 410 are interfaces that transmit/receive a frame 600.

The MAC address table 420 includes MAC entries. In a MAC entry 421, keys are “OVID and destination MAC address”, and an action is “output port designation”. Namely, when the frame 600 including the “OVID and destination MAC address” designated in the MAC entry is received, an output port can be determined.

Here, the flow processing apparatus 400D receives a frame 600B of “OVID: N1, IVID: B1, source MAC address: M1” from the flow processing apparatus 400B. In this case, the MAC address table 420 in the flow processing apparatus 400 learns a forwarding rule that indicates “forwarding, to the port 410B, a frame whose destination MAC address is M1, and OVID is N1” in response to receipt of the frame 600B (MAC learning).

After the frame 600B is received, the flow processing apparatus 400D receives a frame 600C of “OVID: N1, IVID: B2, source MAC address: M1” from the flow processing apparatus 400C. In this case, the MAC address table 420 in the flow processing apparatus 400 updates the forwarding rule that indicates “forwarding, to the port 410B, a frame whose destination MAC address is M1 and OVID is N1” to a forwarding rule that indicates “forwarding, to the port 410C, a frame whose destination MAC address is M1 and OVID is N1” in response to receipt of the frame 600C (MAC movement).

The flow processing apparatus 400D then receives a frame 600A of “OVID: N1, IVID: B1, source MAC address: M1, destination MAC address: M1” from the flow processing apparatus 400A. In this case, the flow processing apparatus 400D forwards the frame 600A in accordance with the updated forwarding rule that indicates “forwarding, to the port 410C, a frame whose destination MAC address is M1, and OVID is N1”. Since in the frame 600A, the destination MAC address is “M1”, an original forwarding destination thereof is a “port 410B”. However, updating the MAC address table 420, based on the frame 600C, results in a problem in that the frame 600A is forwarded to the “port 410C” differing from the original forwarding destination (“port 410B”). This also raises a problem in that since the MAC table 420 is rewritten (MAC moved) every time the frame 600B and frame 600C are received, the frame 600A is forwarded sometimes to the “port 410B” but other times to the “port 410C”.

Thus, in the first example embodiment, the flow processing apparatus 400 detects an occurrence of MAC duplication and notifies the occurrence of MAC duplication to the flow control apparatus 100. The flow control apparatus 100 that has received the notification of the occurrence of MAC duplication changes the configuration of the virtual network in such a way that each of the frames in the state of MAC duplication belongs to different virtual networks from each other. When each of the frames in the state of MAC duplication becomes to belong to different virtual networks from each other, the OVIDs stored in each of the frames are altered to different OVIDs from each other. Therefore, in the first example embodiment, MAC duplication is prevented.

The flow processing unit 401 in the flow processing apparatus 400 registers a forwarding rule using the source MAC address, the OVID, and the IVID to the MAC duplication table 490 in response to receipt of the frames (e.g., frame 600B and frame 600C) that includes duplicate source MAC addresses and duplicate OVIDs from each of different input ports. For example, when the flow processing apparatus 400D receives the frame 600C following the frame 600B, the flow processing apparatus 400D, based on the frame 600C, learns a duplication entry that indicates a destination “forwarding, to the port 410C, a frame whose destination MAC address is M1, OVID is N1, and IVID is B2” in the MAC duplication table 490.

The flow processing unit 401 in the flow processing apparatus 400 performs, to the flow control apparatus 100, a predetermined notification in which “MAC duplication has occurred” is indicated in response to detection of the occurrence of MAC duplication. In addition, the flow processing unit 401 in the flow processing apparatus 400 performs, to the flow control apparatus 100, a predetermined notification in which “MAC duplication has occurred” is indicated, in response to registration of the duplication entry to the MAC address table 490. The predetermined notification includes information concerning to each of frames in which MAC duplication has occurred. The information concerning to each of frames in which MAC duplication has occurred includes, for example, the OVID and IVID stored in the each of frames in which MAC duplication has occurred. The information concerning to the each of frames in which MAC duplication has occurred may be, for example, the duplication entry registered in the MAC duplication table 490. The information concerning to the each of frames in which MAC duplication has occurred may be, for example, the frame itself in which MAC duplication has occurred. Note that the predetermined notification is not limited to the signal in which “MAC duplication has occurred” is indicated, and may be, for example, a signal in which “the duplication entries have been registered” is indicated or the like.

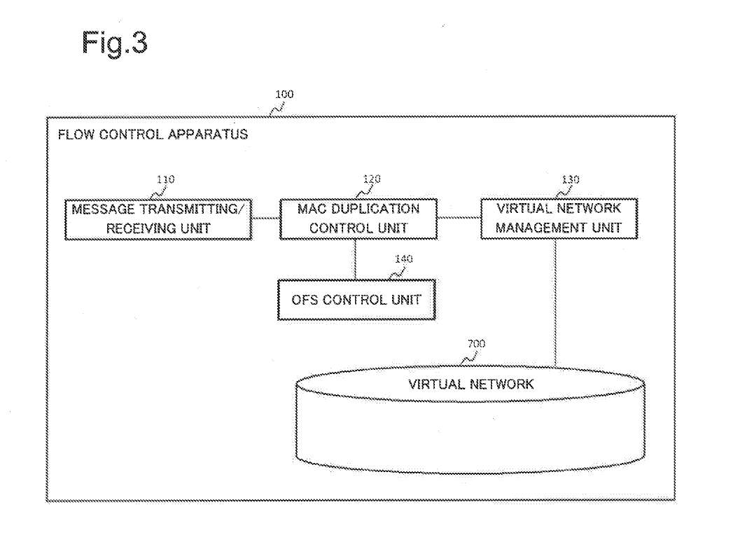

FIG. 3 is a diagram illustrating a configuration example of the flow control apparatus 100 in the first example embodiment. As illustrated in FIG. 3, the flow control apparatus 100 includes a message transmitting/receiving unit 110, a MAC duplication control unit 120, a virtual network management unit 130, an OFS control unit 140, and a virtual network 700 (e.g., a virtual network 700 configured in a memory or a database).

The message transmitting/receiving unit 110 includes a function that performs communication with the flow processing apparatus 400.

The message transmitting/receiving unit 110 is, for example, an interface to perform communication.

The MAC duplication control unit 120 instructs the virtual network management unit 130 to separate the virtual network with MAC duplication in response to receipt of the predetermined notification in which “MAC duplication has occurred” is indicated from the flow processing apparatus 400. The MAC duplication control unit 120 instructs to separate the virtual network with MAC duplication, based on the OVIDs and the IVIDs included in notified information received from the flow processing apparatus 400.

The virtual network management unit 130 executes separation of the virtual network with MAC duplication in response to the instruction from the MAC duplication control unit 120. For example, the virtual network management unit 130 moves a virtual bridge with MAC duplication from a current virtual network to another virtual network in response to the instruction from the MAC duplication control unit 120.

The OFS control unit 140 notifies a message of flow change to the flow processing apparatus 400, based on the virtual network having been separated.

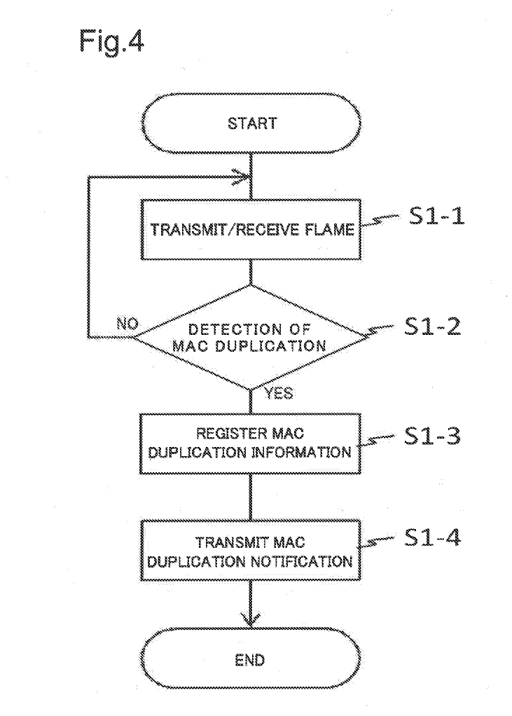

FIG. 4 is a flow chart illustrating an example of operations of the flow processing apparatus 400 in the first example embodiment.

The port 410 in the flow processing apparatus 400 performs transmission/receipt of a frame (S1-1).

The flow processing unit 401 in the flow processing apparatus 400 detects presence or absence of the occurrence of MAC duplication (S1-2). For example, the flow processing unit 401 detects that MAC duplication has occurred in response to receipt of the frames (e.g., the frame 600B and the frame 600C) include duplicate source MAC addresses and duplicate OVIDs from each of different input ports.

When the flow processing unit 401 detects the occurrence of MAC duplication (YES in S1-2), the flow processing unit 401 registers MAC duplication information (MAC duplication entry) to the MAC duplication table 490 (S1-3). For example, when the flow processing unit 401 receives the frame 600C following the frame 600B, the flow processing unit 401 learns, based on the frame 600C, a duplication entry that indicates a destination “forwarding, to the port 410C, a frame whose destination MAC address is M1, OVID is N1, and IVID is B2” in the MAC duplication table 490.

When the flow processing unit 401 detects the occurrence of MAC duplication, the flow processing unit 401 performs a predetermined notification in which “MAC duplication has occurred” is indicated to the flow control apparatus 100 (S1-4).

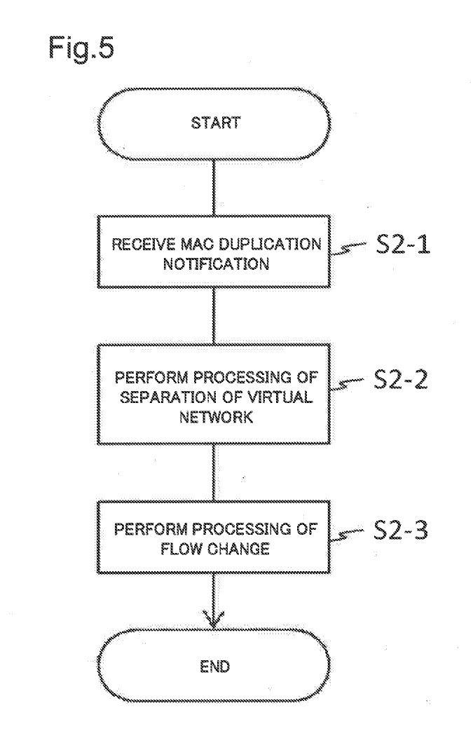

FIG. 5 is a flow chart illustrating an example of operations of the flow control apparatus 100 in the first example embodiment.

The MAC duplication control unit 120 in the flow control apparatus 100 receives a predetermined notification in which “MAC duplication has occurred” is indicated through the message transmitting/receiving unit 110 from the flow processing apparatus 400 (S2-1).

The MAC duplication control unit 120 instructs the virtual network management unit 130 to separate the virtual network with MAC duplication in response to receipt of the predetermined notification in which “MAC duplication has occurred” is indicated (S2-2). The MAC duplication control unit 120 instructs to separate the virtual network with MAC duplication, based on the OVIDs and the IVIDs included in the notified information received from the flow processing apparatus 400. The virtual network management unit 130 executes separation of the virtual network with MAC duplication in response to the instruction from the MAC duplication control unit 120. For example, the virtual network management unit 130 moves a virtual bridge with MAC duplication from a current virtual network to another virtual network in response to the instruction from the MAC duplication control unit 120.

The OFS control unit 140 notifies the message of flow change to the flow processing apparatus 400, based on the virtual network having been separated (S2-3).

As described above, in the first example embodiment, the flow processing apparatus 400 detects the occurrence of MAC duplication and notifies the occurrence of MAC duplication to the flow control apparatus 100. The flow control apparatus 100 that has received the notification of the occurrence of MAC duplication changes the configuration of the virtual network in such a way that each of the frames in the state of MAC duplication belongs to different virtual networks from each other. When each of the frames in the state of MAC duplication becomes to belong to different virtual networks from each other, the OVIDs stored in the each of the frames are altered to different OVIDs from each other. Therefore, in the first example embodiment, MAC duplication is prevented.

### Second Example Embodiment

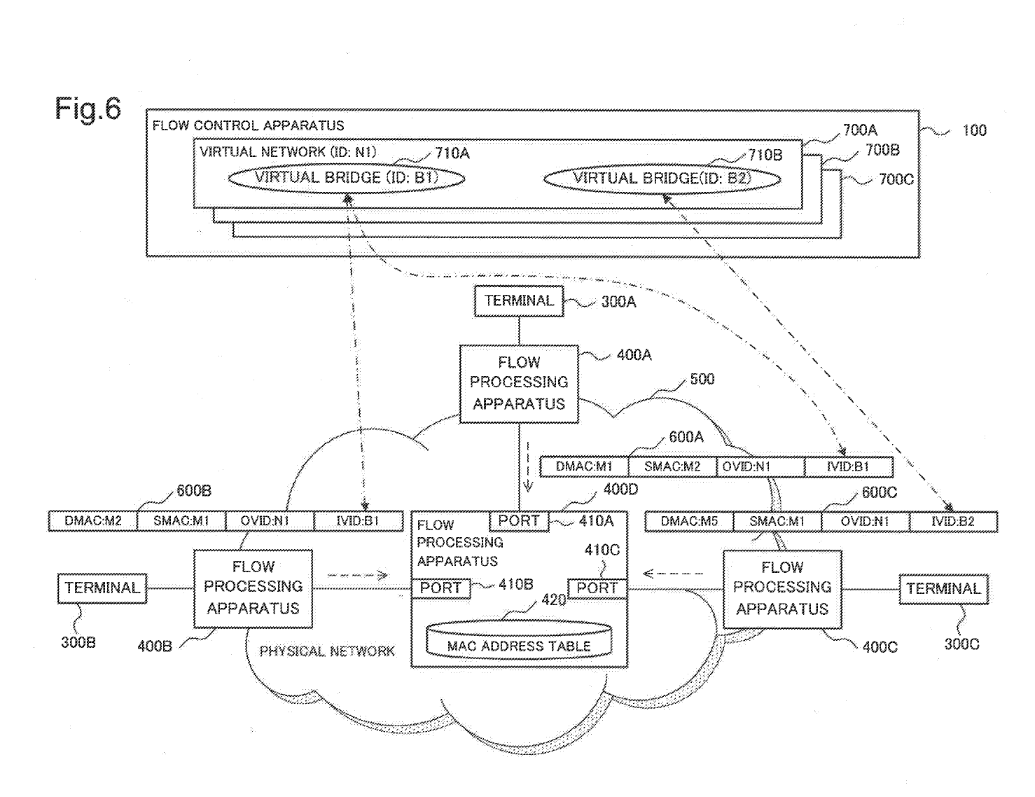

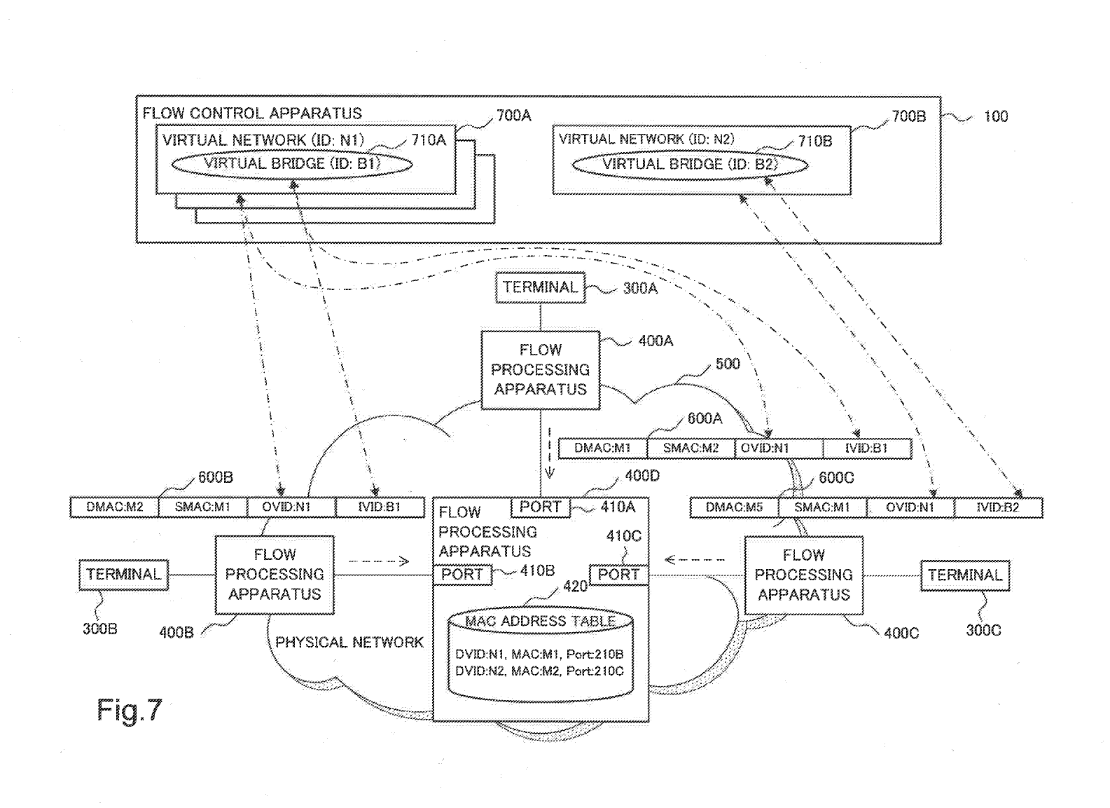

FIG. 6 and FIG. 7 are a diagram illustrating a system configuration example of a communication system in a second example embodiment of the present invention. Note that FIG. 6 is a system configuration example before separation of virtual networks by the flow control apparatus 100, and FIG. 7 is a system configuration example after separation of the virtual networks by the flow control apparatus 100.

Note that a technique of the second example embodiment can be applied to both of the first example embodiment and example embodiments described later.

In FIG. 6 and FIG. 7, the communication system includes, for example, a flow control apparatus 100, terminals 300, and flow processing apparatuses 400.

Note that since the terminals 300 are the same component as the terminals 300 of the communication system in the first example embodiment illustrated in FIG. 1, detailed explanations thereof will be omitted.

A physical network 500 includes, for example, the flow processing apparatuses 400 and provides a physical environment to realize forwarding of frames in virtual networks using virtual networks 700 and virtual bridges 710A and 710B.

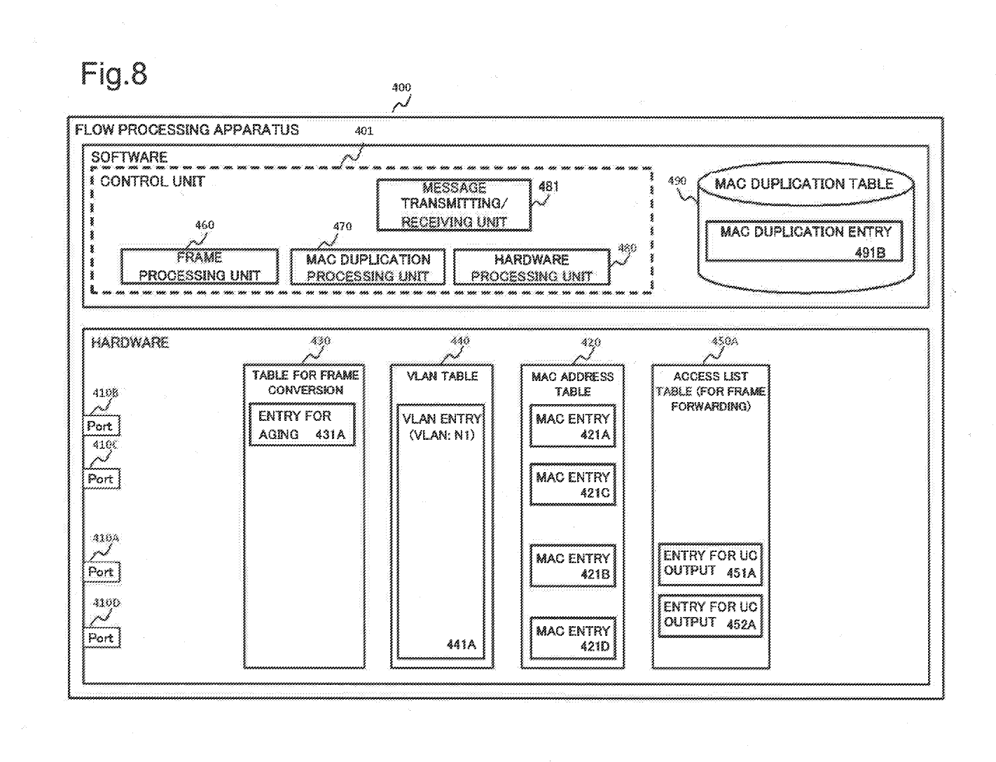

FIG. 8 is a diagram illustrating a configuration example of the flow processing apparatus 400 in the second example embodiment. The flow processing apparatus 400 includes ports 410, a table for frame conversion 430, a VLAN table 440, a MAC address table 420, and an access list table (for frame forwarding) 450A. In addition, the flow processing apparatus 400 includes a frame processing unit 460, a MAC duplication processing unit 470, a hardware processing unit 480, a message transmitting/receiving unit 481, and a MAC duplication table 490.

In the flow processing apparatus 400, the ports 410, the table for frame conversion 430, the VLAN table 440, the MAC address table 420, and the access list table (for frame forwarding) 450A are configured as a hardware. The frame processing unit 460, the MAC duplication processing unit 470, the hardware processing unit 480, the message transmitting/receiving unit 481, and the MAC duplication table 490 are configured as a software.

Here, when a frame 600B and a frame 600C pass through the MAC address table 420 in the hardware, the frame processing unit 460 in the flow processing apparatus 400 detects MAC movement. The MAC movement is processing in that for a forwarding rule in which the OVIDs and the destination MAC addresses are the same, the forwarding rule is rewritten in the MAC address table 420. For example, when the frame 600B passes through the MAC address table 420, the MAC address table 420 learns a forwarding rule that indicates “forwarding, to the port 410B, a frame whose destination MAC address is M1, and OVID is N1”. When the frame 600C passes through the MAC address table 420 after the passage of the frame 600B, the MAC address table 420 rewrites the forwarding rule that indicates “forwarding, to the port 410B, a frame whose destination MAC address is M1, and OVID is N1” to a forwarding rule that indicates “forwarding, to the port 410C, a frame whose destination MAC address is M1, and the OVID is N1”.

As described above, since the frames 600B and 600C include different IVIDs but include the same OVIDs and the same source MAC addresses, key information (OVID and MAC address) thereof learned by the MAC address table 420 in the flow processing apparatus 400 is the same. Thus, every time the frames 600B, 600C are received, the MAC entry (forwarding rule) in the MAC address table 420 repeats MAC movement between ports 410B and 410C. When the flow processing apparatus 400 receives the frame 600B whose destination is the MAC address: M1, the flow processing apparatus 400 transmits the frame 600C not only to a correct destination port 410B but also to a wrong destination port 410C because the flow processing apparatus 400 transmits the frame 600C toward the port in the MAC entry (forwarding rule) in the MAC address table.

Then, in the second example embodiment, the flow processing apparatus 400 detects the occurrence of MAC duplication and notifies the occurrence of MAC duplication to the flow control apparatus 100. The flow control apparatus 100 that has received the notification of the occurrence of MAC duplication moves each of the virtual bridges in which MAC duplication has occurred to different virtual networks from each other. As a result, since each of the frames in the state of MAC duplication becomes to belong to different virtual networks from each other, the OVIDs stored in the each of the frames are altered to different OVIDs from each other. Therefore, in the second example embodiment, MAC duplication is prevented.

The port 410 is an interface that transmits/receives a frame 600. Note that the received frame 600 is subjected to pipeline processing in order the port 410, the table for frame conversion 430, the VLAN table 440, the MAC address table 420, and the access list table (for frame forwarding) 450A.

The table for frame conversion 430 is a table that implements VLAN conversion of the frame 600. Note that the table for frame conversion 430 includes a function for updating the frame 600 and can also execute any other action for the frame 600. In the second example embodiment, for example, the table for frame conversion 430 is used for executing an action for cancellation of MAC learning.

The VLAN table 440 includes a VLAN entry 441. In the VLAN entry 441, a key is “OVID”, and an action is “frame trunking (e.g., an action for proceeding to processing of the MAC address table 420 in a later part)”. In the VLAN table 440, when there is no entry corresponding to the input frame 600, the frame 600 is discarded. The VLAN table 440 executes registration/updating/deletion of the VLAN entry 441 by instructions of the flow control apparatus 100 or configurations of the flow processing apparatus 400.

The MAC address table 420 includes MAC entries. In the MAC entry 421, keys are “OVID and destination MAC address”, and an action is “output port” designation. Namely, when a frame 600 including the “OVID and destination MAC address” designated in the MAC entry is received, an output port can be determined. The MAC entry 421 is automatically registered/updated/deleted by the hardware. When there is no MAC entry 421 whose key is “OVID and destination MAC address” included in the frame 600 received in the MAC address table 420, MAC learning is executed (i.e., a new MAC entry is registered). When there is such a MAC entry 421 but the output port 410 designated in the MAC entry 421 and the input port 410 of the frame 600 are different, information of the output port designated in the MAC entry 421 (port's identifier, port number or the like) is updated to information of the input port of the frame (port's identifier, port number or the like) (MAC movement).

Note that, in the MAC address table 420, when the frame 600 identical to the key in the MAC entry is not received until a predetermined time “aging set period” is over, the MAC entry is deleted.

The access list table (for frame forwarding) 450A is a table for frame forwarding. When a frame 600 that has hit for an entry included in the access list table (for frame forwarding) 450A is received, an action of the hit entry is applied to the frame 600.

Furthermore, the access list table (for frame forwarding) 450A includes, in a logic table, “entry priority” that indicates a degree of priority in the application to the frame 600. For example, each of entries included in the access list table (for frame forwarding) 450A includes a degree of priority, and when there are a plurality of entries hitting for the input frame 600, the action designated in the entry with high degree of priority is preferentially applied to the frame 600. Note that in the figures of the second example embodiment, it is assumed that an entry described in higher level (upper position) in the access list table (for frame forwarding) 450A is an entry with a high priority.

An entry for UC output 451A included in the access list table (for frame forwarding) 450A is an entry for which only frames 600 that have hit for the MAC entry 421 in the MAC address table 420 hit and plays a role that outputs the frame 600 from the port 410 designated by the MAC entry 421.

When the frame 600 does not hit for the entry for UC output (is not MAC learned), the frame 600 hits for “entry for Flooding output” with lower degree of priority than the entry for UC output 451A, and the frame 600 is subjected to Flooding output. The entry for UC output and the entry for Flooding output are registered/updated/deleted in the access list table 250 by instruction of the flow control apparatus 100.

When MAC movement in the MAC address table 420 occurs, the frame processing unit 460 receives the frame 600 causing the MAC movement or a copy thereof. The frame processing unit 460 notifies the frame 600 or the copy thereof to MAC duplication processing unit 470.

The MAC duplication processing unit 470 registers an entry to the MAC duplication table 490, based on information of the frame 600 received from the frame processing unit 460 (header information or the like). For example, the MAC duplication processing unit 470 registers, to the MAC duplication table 490, the MAC duplication entries 491A and 491B corresponding to the frames 600A and 600B, respectively and manages them as MAC entries in a format including the IVIDs.

Furthermore, the MAC duplication processing unit 470 instructs the hardware processing unit 480 to register/update/delete the entries of each table in the hardware, based on the information of the frame 600 received from the frame processing unit 460 (header information etc.). For example, the MAC duplication processing unit 470 instructs the table for frame conversion 430 to register entries for aging 431A and 431B in the hardware, based on information of the MAC duplication entries 491A and 291B in the MAC duplication table 490. The entries for aging 431A, 431B play a role that detects aging in a case where the frames 600A, 600B are not received any longer.

In the entry for aging 431, keys are “OVID, IVID, source MAC address, input port”, and an action is “cancel MAC learning; and WriteMetadata”. The cancellation of MAC learning plays a role that, when the frame hitting for the entry for aging 431 is received in the MAC address table 420, prevents the MAC address table 420 from MAC learning. The WriteMetadata plays a role that enables the MAC address table 420 to retain, as Frame information, the fact in that the frame has hit for the entry for aging 431.

Furthermore, the MAC duplication processing unit 470 instructs the access list table (for frame forwarding) 450A to register the entries for UC output 451A and 452A. The entries for UC output 451A, 452A play a role for outputting the frame in which duplicate MAC has occurred to a correct port. For example, the access list table (for frame forwarding) 450A registers, as the entry for UC output 451A, a content that indicates “forwarding, to a port 1, a frame whose source MAC address is M1, OVID is N1, and IVID is B1”. In addition, the access list table (for frame forwarding) 450A registers, as the entry for UC output 452B, a content that indicates “forwarding, to a port 2, a frame whose source MAC address is M1, OVID is N1, and IVID is B2”.

The hardware processing unit 480 registers/updates/deletes the entry to/to/from each table in the hardware in accordance with instruction of the MAC duplication processing unit 470. In addition, the hardware processing unit 480 detects age out of the MAC duplication entry from statistical information (frame statistics) of the frame in the entry for aging 431. When the hardware processing unit 480 detects age out, the hardware processing unit 480 notifies the age out to the MAC duplication processing unit 470.

As described above, the entry for UC output 452 and the entry for aging 431 enable to prevent the flow processing apparatus 400 from misforwarding as well as also enable to keep pace with aging.

Furthermore, the MAC duplication processing unit 470 instructs each table configured on the hardware to delete the MAC entry 421A. The deletion of the MAC entry 421A enables to shift forwarding processing of the frame 600 into UC forwarding because MAC learning is operated quickly on the hardware even if new MAC duplication further occurs.

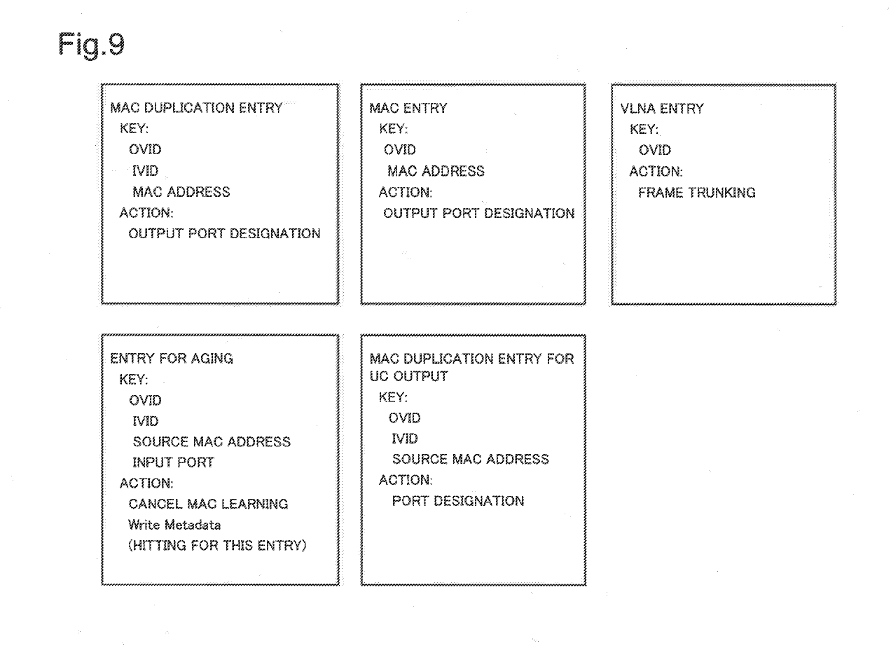

FIG. 9 is a diagram illustrating examples of configurations of entries that are stored in each table described above. As illustrated in FIG. 9, in the MAC duplication entry, keys are “OVID, IVID, and MAC address”, and an action is “output port designation”. Furthermore, in the MAC entry, keys are “OVID and MAC address”, and an action is “output port designation”. In the VLAN entry, a key is “OVID”, and an action is “frame trunking”.

In the entry for aging, keys are “OVID, IVID, source MAC address”, and an action is “cancel MAC learning; WriteMetadata”.

In the MAC duplication entry for UC output, keys are “OVID, IVID, and destination MAC address”, and an action is “port designation”.

In the second example embodiment, the flow control apparatus 100 is the same configuration as the flow control apparatus 100 of the communication system in the first example embodiment illustrated in FIG. 3.

A message transmitting/receiving unit 110 in the flow control apparatus 100 receives a MAC duplication notification from a message transmitting/receiving unit 481 in the flow processing apparatus 400. The MAC duplication notification is a predetermined notification in which “MAC duplication has occurred” is indicated. The MAC duplication notification includes, for example, information concerning to each of frames in which MAC duplication has occurred. The information concerning to the each of frames in which MAC duplication has occurred is, for example, the duplicate entry registered in the MAC duplication table 490. The message transmitting/receiving unit 110 forwards the received MAC duplication notification to the MAC duplication control unit 120.

The MAC duplication control unit 120 extracts, from the received MAC duplication notification, an ID of a virtual network (OVID) and IDs of virtual bridges (IVIDs) in which MAC duplication has occurred and instructs the virtual network management unit 130 to separate the extracted virtual bridges into different virtual networks. In addition, the MAC duplication control unit 120 transmits, to the OFS control unit 140, a control message concerning to processing of frame conversion and processing of flow change related to a VLAN tag from information of the separated virtual network (OVID, IVID).

For example, the virtual network management unit 130 moves each of the virtual bridges with MAC duplication to different virtual network data from each other, based on the virtual bridges 710 in the virtual network 700 stored in the memory and/or the database (separation of the virtual network). When the separation of the virtual network is completed, the virtual network management unit 130 transmits information of the separated virtual networks to the MAC duplication control unit 120. The information of the separated virtual networks includes each ID of the virtual networks (OVID) and each ID of the virtual bridges (IVID) after the separation.

The OFS control unit 140 prepares and transmits a message of flow change through the message transmitting/receiving unit 110 to the flow processing apparatus. The message of flow change is, for example, a flow entry in the OpenFlow.

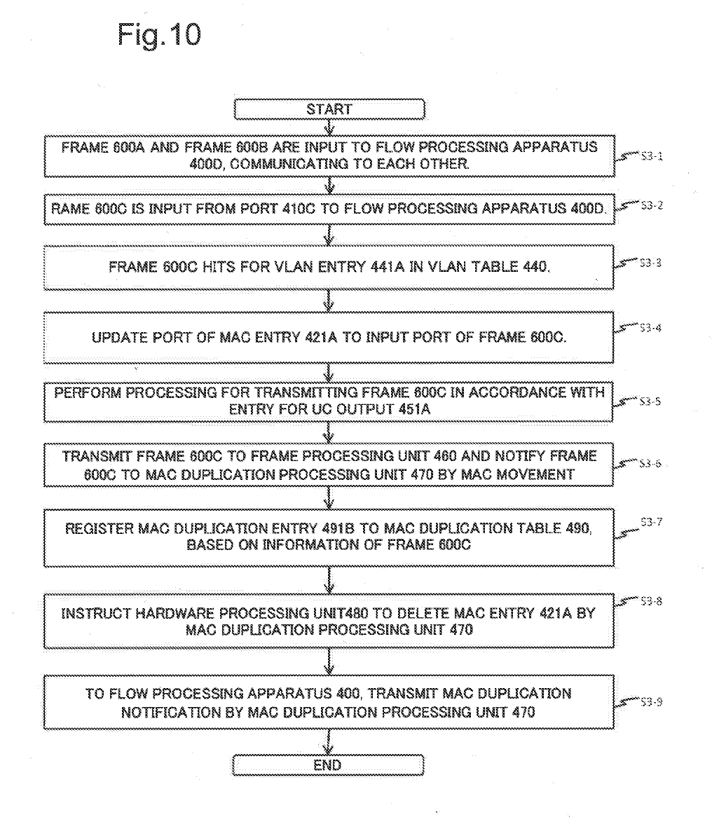

FIG. 10 is a flow chart illustrating an example of operations of the flow processing apparatus 400 in the second example embodiment.

The terminal 300A and terminal 300B communicate to each other through the flow processing apparatus 400 (S3-1). Specifically, the flow processing apparatus 400 receives a frame 600A of “OVID: N1, IVID: B1, source MAC address: M1, destination MAC address: M1” from a port 410A and forwards the frame through a port 410B. Furthermore, the flow processing apparatus 400 receives a frame 600B of “OVID: N1, IVID: B1, source MAC address: M1, destination MAC address: M2” from the port 410B and forwards the frame through the port 410A.

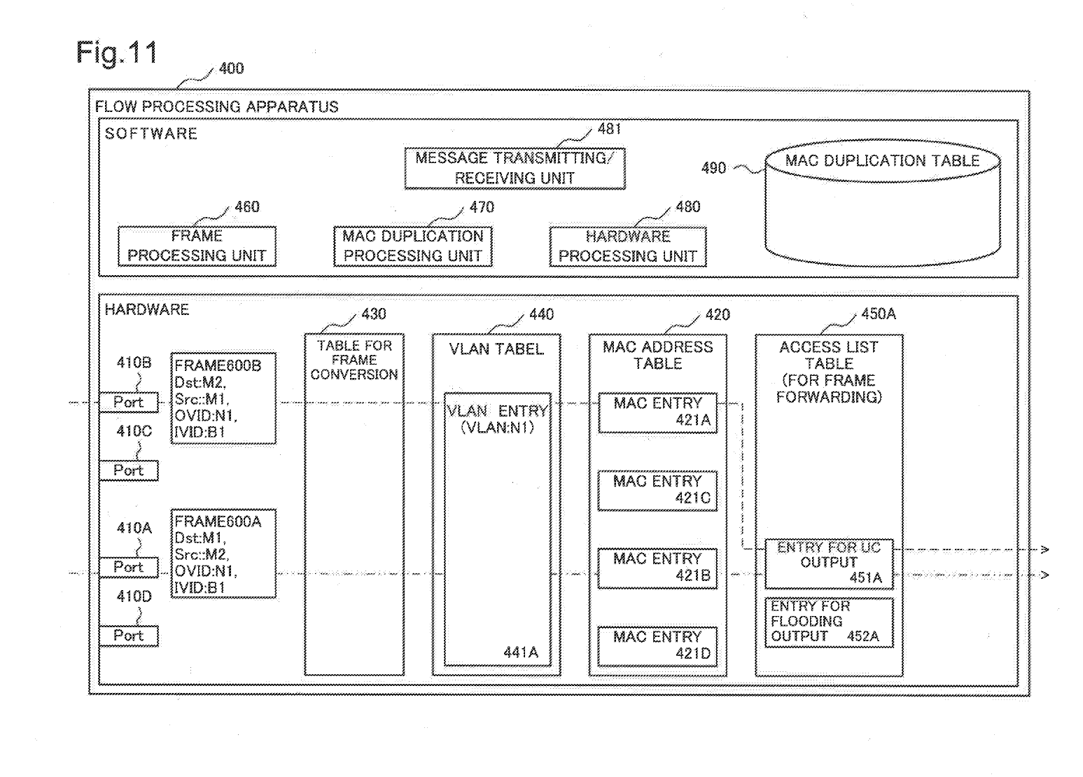

FIG. 11 is a diagram illustrating the configuration example of the flow processing apparatus 400 in a case where the terminal 300A and terminal 300B communicate to each other.

The flow processing apparatus 400 receives the frame 600A through the port 410A from the terminal 300A. As a result, the MAC address table 420 in the flow processing apparatus 400 learns a MAC entry 421B of “forwarding, to the port 410A, a frame whose destination MAC address is M2, and OVID is N1”. On the other hand, the flow processing apparatus 400 receives a frame 600B through the port 410B from the terminal 300B. As a result, the MAC address table 420 in the flow processing apparatus 400 learns a MAC entry 421A of “forwarding, to the port 410B, a frame whose destination MAC address is M1, and OVID is N1”. As a result, as illustrated in FIG. 8, in a MAC address table 420, the MAC entry 421A, and the MAC entry 421B are learned. Note that the flow processing apparatus 400 in FIG. 8 has learned previously the MAC entry 421C and the MAC entry 421D.

When the flow processing apparatus 400 receives the frame 600B, the flow processing apparatus 400 executes forwarding processing of the frame 600B in accordance with the MAC entry 421B registered in the MAC address table 420. Furthermore, when the flow processing apparatus 400 receives the frame 600A, the flow processing apparatus 400 executes forwarding processing of the frame 600A in accordance with the MAC entry 421A registered in the MAC address table 420.

In addition, as illustrated in FIG. 11, in the access list table (for frame forwarding) 450A, the entry for UC output 451A and the entry for Flooding output 452A are registered. As illustrated in FIG. 11, the frame 600 that has hit for the MAC entry 421 registered in the MAC address table 420 is forwarded from the port 410 designated in the MAC entry 421 in accordance with the entry for UC output 451A. For example, the frame 600A is forwarded from the port 410A designated in the MAC entry 421A in accordance with the entry for UC output 451A.

Next, the flow processing apparatus 400 receives a frame 600C of “OVID: N1, IVID: B2, source MAC address: M1, destination MAC address: M5” from the port 410C (S3-2). The frame 600C is proceeded to the processing of the MAC address table 420 because the frame 600C hits for a VLAN entry 441A in the VLAN table 440 (S3-3).

When the flow processing apparatus 400 receives a frame 600C, the MAC entry 421B in the MAC address table 420 is rewritten to a content that indicates “forwarding, to the port 410C, a frame whose destination MAC address is M1, and OVID is N1” (MAC movement). Namely, since the frame 600C includes the same key as the key “OVID: N1, source MAC address M1” of the MAC entry 421A that is already learned in the MAC address table 420 but includes a different port, the port in the MAC entry 421 is updated to the input port 410C of the frame 600C (S3-4).

The flow processing apparatus 400 executes forwarding processing of the frame 600C in accordance with the destination MAC entry 421C that is previously learned in the MAC address table 420 and the entry for UC output 451A that is registered in the access list table (for frame forwarding) 450A (S3-5).

The flow processing apparatus 400 notifies the frame 600C to the frame processing unit 460 in response to the occurrence of MAC movement (MAC duplication) in the MAC address table. The frame processing unit 460 notifies the frame 600C to the MAC duplication processing unit 470 (S3-6).

The MAC duplication processing unit 470 registers the MAC duplication entry 491B to a MAC duplication table 490, based on information included in the frame 600C (e.g., header information) (S3-7). The MAC duplication entry 491B is an entry including “OVID: N1, IVID: B2, destination MAC address: M1” as keys and “port 410C” as an output port.

The MAC duplication processing unit 470 instructs the hardware processing unit 480 to delete the MAC entry 421A. The MAC duplication processing unit 470 deletes the instructed MAC entry 421A (S3-8).

By deleting the MAC entry 421A, even if a frame received subsequently is the frame 600C or the frame 600B, it is possible to operate MAC learning quickly and shift to the UC forwarding.

In addition, in a case where not MAC duplication but MAC movement, since the software is not notified the frame in the flow processing apparatus 400, the flow processing apparatus 400 performs processing for deleting the MAC duplication entry 491B from the MAC duplication table 490 after a lapse of a certain time.

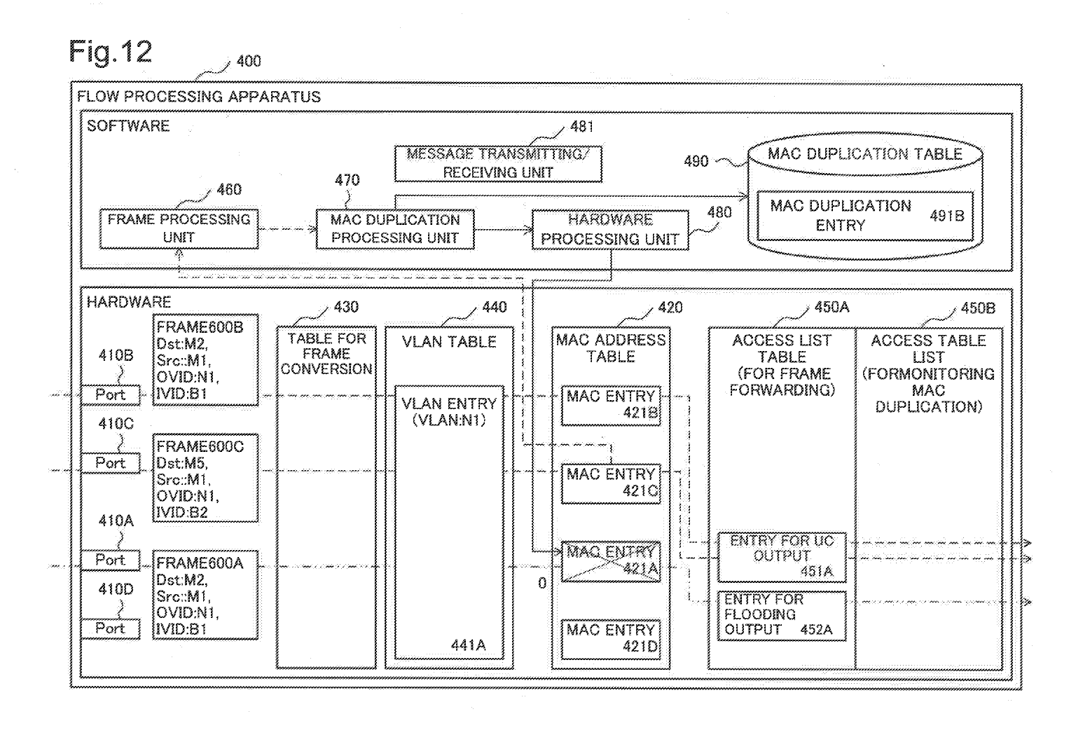

FIG. 12 is a diagram illustrating a configuration example of the flow processing apparatus 400 in a case where a frame 600C is received through the port 410C in the flow processing apparatus 400, in the state of FIG. 11.

In the MAC address table 420 in the flow processing apparatus 400, since the MAC movement occurs by the frame 600C being received, the frame processing unit 460 receives a notification of the frame 600C.

The MAC duplication processing unit 470 registers the MAC duplication entry 491B to the MAC duplication table 490 by the frame 600C being notified from the frame processing unit 460.

In the MAC duplication entry 491B, keys are “OVID, IVID, destination MAC address”, and an action is “output port”. Namely, the MAC duplication entry 491 manages in the software the MAC entry including the IVID that cannot be expressed in the hardware.

In the MAC duplication entry 491B, keys are “OVID: N1, IVID: B2, destination MAC address: M1”, and an action is “input port 410C”. The MAC duplication entry 491B is set, based on the frame 600C.

The MAC entry 421A is deleted through the hardware processing unit 480 by instruction of the MAC duplication processing unit 470. By deleting the MAC entry 421A, the frame 600A whose destination is the MAC address: M1 hits for the entry for Flooding output 452A in the access list table (for frame forwarding) 450A and is subjected to Flooding output.

The MAC duplication processing unit 470 transmits the MAC duplication notification to the flow processing apparatus 400 (S3-9). The MAC duplication notification includes, for example, the MAC duplication entry 491B.

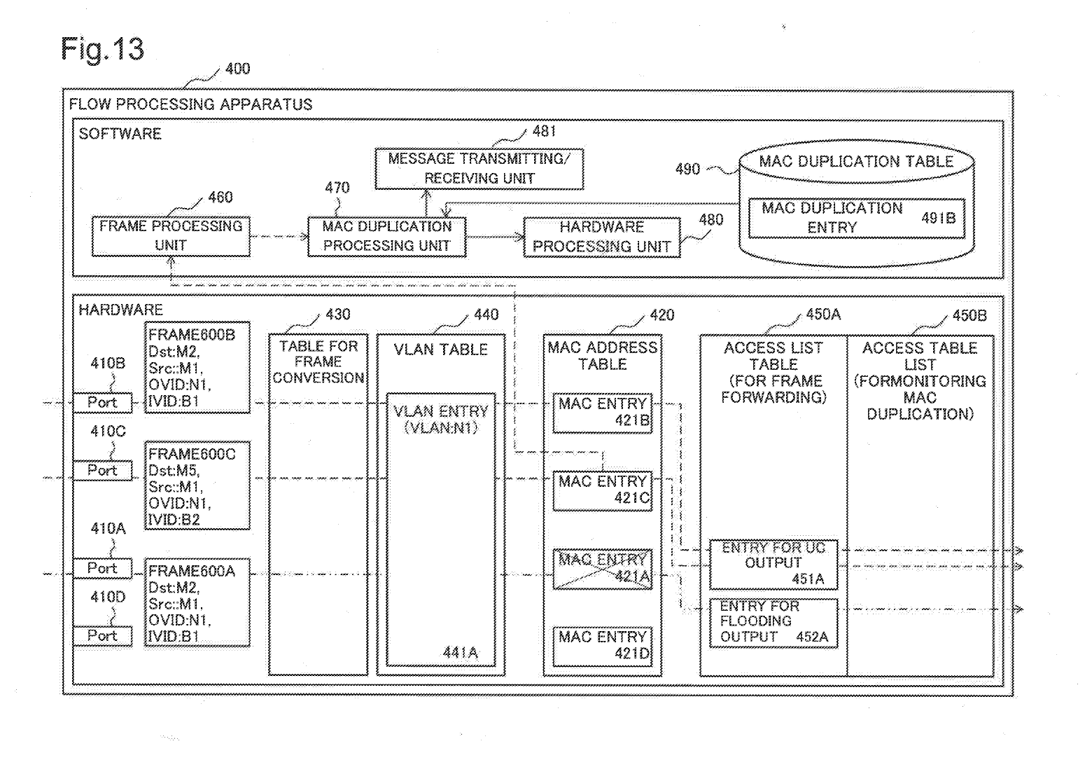

FIG. 13 is a diagram illustrating a configuration example of the flow processing apparatus 400 in a case where the MAC duplication processing unit 470 transmits the MAC duplication notification through the message transmitting/receiving unit 481 to the flow processing apparatus 400 in the state of FIG. 12.

The MAC duplication processing unit 470 instructs to transmit the MAC duplication notification through the message transmitting/receiving unit 481 in response to the MAC duplication entry 491B being registered to the MAC duplication table.

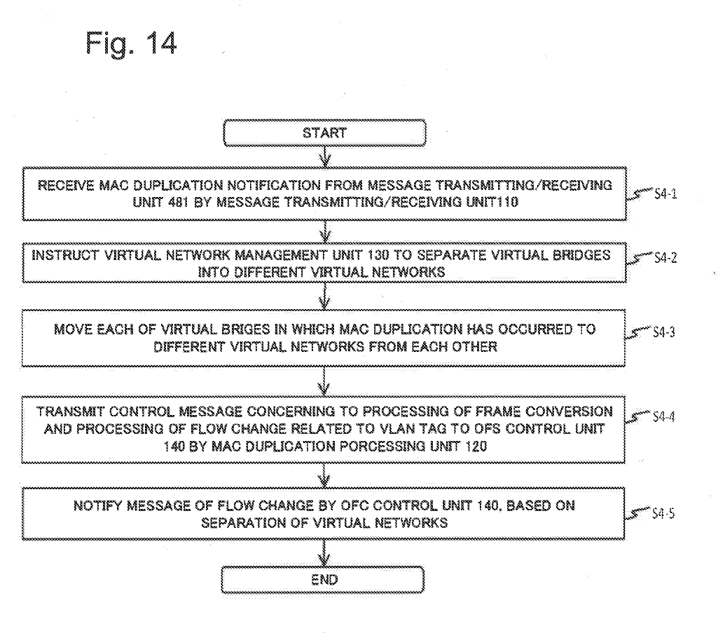

FIG. 14 is a flow chart illustrating an example of operations of the flow control apparatus 100 in the second example embodiment.

The message transmitting/receiving unit 110 in the flow control apparatus 100 receives the MAC duplication notification from the message transmitting/receiving unit 481 in the flow processing apparatus 400 (S4-1). The MAC duplication notification includes, for example, the MAC duplication entry 491B.

In response to the receipt of the MAC duplication notification, the MAC duplication control unit 120 extracts, from the received MAC duplication notification, an ID of a virtual network (OVID) and IDs of virtual bridges (IVIDs) in which the MAC duplication has occurred and instructs the virtual network management unit 130 to separate the extracted virtual bridges into different virtual networks (S4-2).

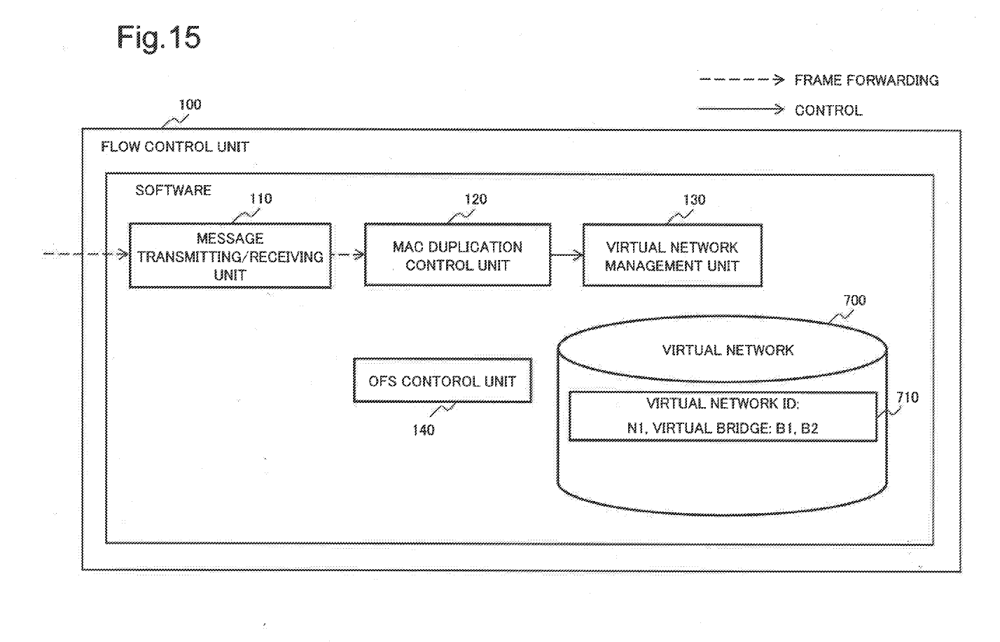

FIG. 15 is a diagram illustrating a configuration example of the flow control apparatus 100 in a case where the MAC duplication notification is received from the flow processing apparatus 400. As illustrated in FIG. 15, when the message transmitting/receiving unit 110 in the flow control apparatus 100 receives the MAC duplication notification, the message transmitting/receiving unit 110 forwards the MAC duplication notification to the MAC duplication control unit 120. The MAC duplication control unit 120 obtains an ID of a virtual network (OVID) and IDs of virtual bridges (IVIDs) in which the MAC duplication has occurred, based on information concerning to each of the frames occurring the MAC duplication that are included in the received MAC duplication notification, and the MAC duplication control unit 120 instructs the virtual network management unit 130 to separate the virtual network.

The virtual network management unit 130 moves each of the virtual bridges in which MAC duplication has occurred to different virtual network data from each other, based on the virtual bridges 710 in the virtual network 700, in response to instruction from the MAC duplication control unit 120 (S4-3).

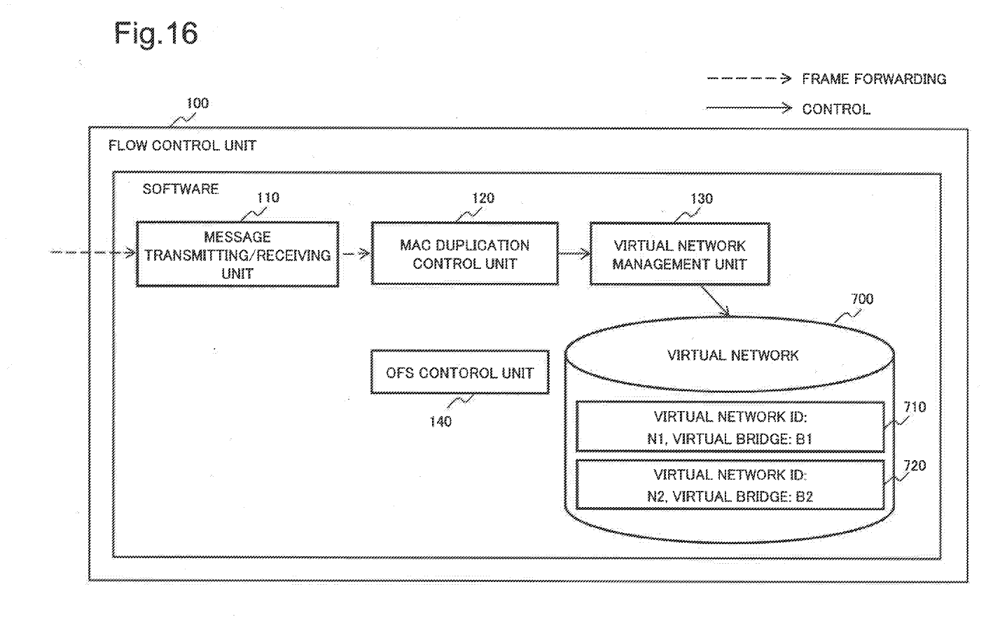

FIG. 16 is a diagram illustrating a configuration example of the flow control apparatus 100 after the virtual network management unit 130 that has received the instruction of separation of the network in FIG. 15 separates the virtual network. As illustrated in FIG. 16, the virtual network management unit 130 separates the each of the virtual bridges (ID: B1, B2) with MAC duplication into a different virtual network (ID: N1) and a different virtual network (ID: N2) from each other. For example, the virtual network management unit 130 separates the virtual bridge (ID: B2) from the virtual bridge 710 and moves the bridge to the virtual network 720.

When the separation of the virtual network is completed, the virtual network management unit 130 transmits information of the separated virtual network to the MAC duplication control unit 120. The information of the separated virtual networks include each ID of the virtual networks (OVID) and each ID of the virtual bridges (IVID) after the separation.

The MAC duplication processing unit 120 transmits, to the OFS control unit 140, a control message concerning to processing of frame conversion and processing of flow change related to a VLAN tag from information of the separated virtual network (OVID, IVID) (S4-4).

The OFS control unit 140 notifies a message of flow change to the flow processing apparatus 400, based on the virtual network having been separated (S4-5).

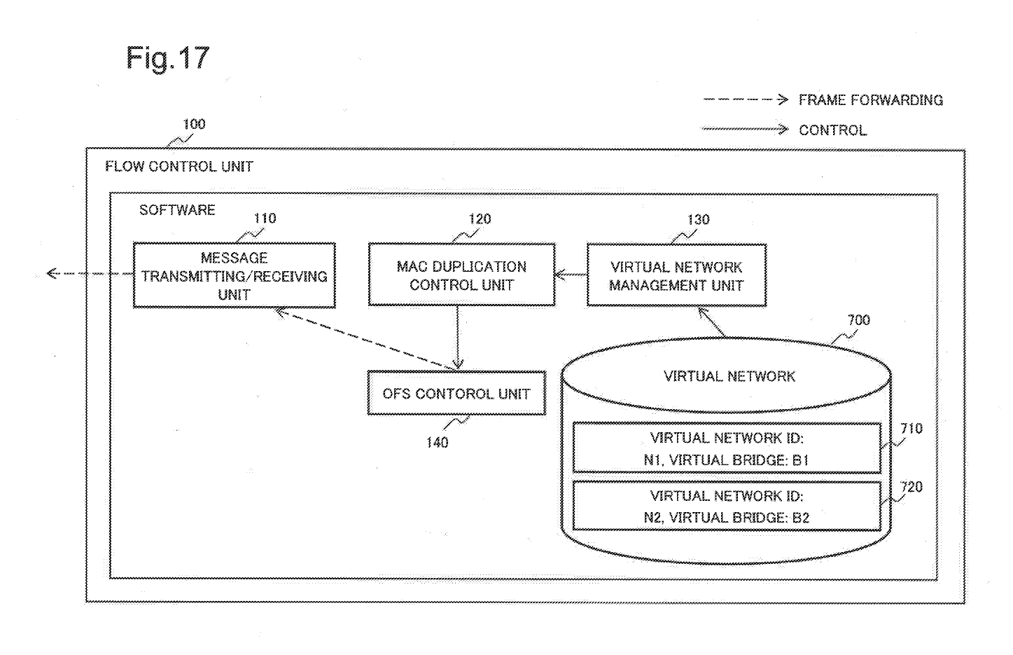

FIG. 17 is a diagram illustrating a configuration example of the flow control apparatus 100 in a case where the OFS control unit 140 transmits, to the flow processing apparatus 400, a message concerning to flow change involved in change of the virtual networks. For flows related to the changed frame involved in the separation of the virtual network, the OFS control unit 140 instructs the flow processing apparatus 400 including rules for processing of the flows to change the rules for processing. The OFS control unit 140 may notify, to the flow processing apparatus 400, the changed rules for processing.

For example, the OFS control unit 140 notifies, to the flow processing apparatus 400C, an instruction for coordinating an OVID of the frame transmitted from the terminal 300C with the virtual network 700B (ID: N2) and for coordinating an IVID of the frame with the virtual bridge 710B (ID: B2).

For the flow change, the OFS control unit 140 adds flows from an Egress side, and implements addition of flows for an Ingress side after completion of the addition of the flows for the Egress side. In order to prevent interception of communication, after the addition of the flows for the Ingress side is completed, the OFS control unit 140 deletes the flows before changed in order of the Ingress side, the Egress side.

FIG. 7 is a system configuration example of a communication system after the separation of the virtual network by the flow control apparatus 100. As illustrated in FIG. 7, for the frame 600C in which the MAC duplication has occurred in FIG. 6, the OVID, the IVID of the frame 600C are altered to correspond to the virtual network 700B, the virtual bridge 710B, respectively, and the occurrence of MAC duplication in the flow processing apparatus 400D is prevented.

As described above, in the second example embodiment, the flow processing apparatus 400 detects the occurrence of MAC duplication and notifies the occurrence of MAC duplication to the flow control apparatus 100. The flow control apparatus 100 that has received the notification of the occurrence of MAC duplication moves each of the virtual bridges in which MAC duplication has occurred to different virtual networks from each other. As a result, since each of the frames in the state of the MAC duplication becomes to belong to different virtual networks from each other, the OVIDs stored in the each of the frames are altered to different OVIDs from each other. Therefore, in the second example embodiment, MAC duplication is prevented.

Although the example embodiments of the present invention are illustrated, the present invention is not limited to each example embodiment described above. The present invention can be implemented based on modifications/replacements/adjustments of each example embodiment.

The present invention can be also implemented in any combination of the example embodiments.

Namely, the present invention includes various modifications and revisions thereof that can be realized in accordance with the entire contents of the disclosure and the technical idea of the present specification.

The present invention can be also applied to the technical field of the software-defined network (SDN).

This application claims priority, based on Japanese patent application No. 2016-68843 filed on Mar. 30, 2016, the entire disclosure of which is incorporated herein.

### REFERENCE SIGNS LIST

100 Flow control apparatus
300 Terminal
400 Flow processing apparatus
401 Flow processing unit
410 Port
420 MAC address table
421 MAC entry
430 Table for frame conversion
431 Entry for aging
440 VLAN table
441 VLAN entry
450 Access list table
451 Entry for UC output
460 Frame processing unit
470 MAC duplication processing unit
480 Hardware processing unit
490 MAC duplication table
491 MAC duplication entry
500 Physical network
600 Frame
700 Virtual network
710 Virtual bridge

1. A communication system, comprising:
a flow processing apparatus that transmits a MAC (Media Access Control) duplication notification indicating an occurrence of MAC duplication, when a plurality of frames received from different ports and belonging to a predetermined virtual network includes same source MAC addresses; and
a flow control apparatus that changes a configuration of the predetermined virtual network, when receiving the MAC duplication notification from the flow processing apparatus.

2. The communication system according to the claim 1, wherein
the flow control apparatus separates the predetermined virtual network in such a way that each of virtual bridges that are sources of the plurality of frames belong to different virtual networks from each other.

3. The communication system according to the claim 1, wherein
the flow processing apparatus stores a MAC duplication entry that includes information concerning to the plurality of frames, when the MAC duplication has occurred.

4. The communication system according to the claim 3, wherein
the flow processing apparatus transmits the MAC duplication notification that includes the MAC duplication entry, and
the flow control apparatus changes the configuration of the predetermined virtual network, based on the MAC duplication entry.

5. The communication system according to claim 1, wherein
the flow processing apparatus transmits the MAC duplication notification including an outer VLAN ID (OVID) that is an identifier of the predetermined virtual network and inter VLAN ID (IVID) that is an identifier of the virtual bridges that are sources of the plurality of frames.

6. The communication system according to the claim 5, wherein
the flow control apparatus separates the predetermined virtual network, based on the OVID and IVID included in the received MAC duplication notification, in such a way that each of virtual bridges that are sources of the plurality of frames belongs to different virtual networks from each other.

7. The communication system according to the claim 5, wherein
the flow processing apparatus stores, in each of the plurality of frames, the OVID and the IVID corresponding each of the frames, based on a notification from the flow control apparatus, and
the flow control apparatus notifies new OVIDs and IVIDs to be stored in each of the plurality of frames to the flow processing apparatus, when the predetermined virtual network has been separated.

8. A flow control apparatus configured to:
perform a requirement for change of a configuration of the predetermined virtual network, when receiving a MAC (Media Access Control) duplication notification indicating an occurrence of MAC duplication in the plurality of frames from the flow processing apparatus; and
change the configuration of the predetermined virtual network in response to the requirement.

9. (canceled)

10. A method for controlling a communication system including a flow processing apparatus and a flow control apparatus, the control method comprising:
transmitting, with the flow processing apparatus, a MAC (Media Access Control) duplication notification indicating an occurrence of MAC duplication when a plurality of frames received from different ports and belonging to a predetermined virtual network include same source MAC addresses; and
changing, with the flow control apparatus, a configuration of the predetermined virtual network, when the MAC duplication notification is received.
